(19) United States
(12) Patent Application Publication
(10) Pub. No.: US 2026/0197150 A1
(43) Pub. Date: Jul. 9, 2026

(54) CLIENT APPARATUS, CONTROL METHOD OF CLIENT APPARATUS, AND STORAGE MEDIUM

(71) Applicant: CANON KABUSHIKI KAISHA, Tokyo (JP)

(72) Inventor: EIJI IMAO, Kanagawa (JP)

(21) Appl. No.: 19/379,540

(22) Filed: Nov. 4, 2025

(30) Foreign Application Priority Data
Nov. 7, 2024 (JP) 2024-195010

(51) Int. Cl. H04L 7/00; G06F 1/12

(52) U.S. Cl. CPC H04L 7/0008; G06F 1/12

(57) ABSTRACT

A time synchronization processing unit communicates with a time distribution server apparatus, which is a time synchronization source, under a time synchronization protocol. Based on the results of the communication, the time synchronization processing unit adjusts the time on the clock of the own apparatus to synchronize with the time on the clock of the time distribution server apparatus. The time synchronization processing unit calculates the reception intervals at which synchronization messages transmitted by the time distribution server apparatus at regular time intervals are received in time synchronization protocol communication, determines whether the reception intervals of the synchronization messages are stable, and adjusts the time on the clock of the own apparatus based on the result of the determination.

### BACKGROUND

### Field of the Technology

The present disclosure relates to a client apparatus, a control method of a client apparatus, and a storage medium.

### Description of the Related Art

In recent years, technologies for synchronizing a plurality of apparatuses to operate as a system in a variety of fields are known. One example is a technology called volumetric video that generates images (moving images or still images) of a three-dimensional model using synchronized images captured by a plurality of imaging apparatuses (for example, digital cameras, digital video cameras, and the like) and create a three-dimensional image that can be viewed from any viewpoint. In applying such technologies, a plurality of imaging apparatuses may perform time synchronization by communicating with each other via a network in order to synchronize the imaging timings of the imaging apparatuses.

Precision Time Protocol Version 2 (PTP Version 2) is technology for synchronizing time among a plurality of apparatuses by communication over a network. Precision Time Protocol Version 2 is prescribed in the IEEE 1588-2008 standard. PTP, also called time synchronization protocol, is a communication protocol for time adjustment via communication. PTP enables high precision continuous synchronization between the time on a client apparatus and the time on a time distribution server apparatus called a Grand Master Clock (GMC) through communication between the client apparatus and the server apparatus.

In a situation where time adjustment by PTP is performed via a wireless local area network (LAN), it may be affected by a communication data collision avoidance mechanism such as Carrier Sense Multiple Access/Collision Avoidance (CSMA/CA). Under such circumstances, random waits for transmission may occur after time stamping of transmission of packets required for PTP. In addition, due to the influence of the wireless environment or other communication apparatuses performing wireless communication, PTP packets may be lost due to radio wave reflection, attenuation, interference, and the like, and a PTP packet retransmission process may be executed. The PTP packet transmission wait process and retransmission process may cause jitter of PTP communication delay.

PTP assumes that the communication delay time between the time distribution server apparatus and the client apparatus is constant in both directions. Accordingly, jitter of communication delay in wireless communication can cause a deterioration in the precision of time synchronization between the client apparatus and the time distribution server.

In view of such circumstances, where jitter and/or communication delay occur, a method for controlling PTP packets deemed to have had a large communication delay so as not to be used in time synchronization processing has been proposed. Japanese Patent Laid-Open No. 2014-165582 describes a method for measuring a plurality of communication delay times between a time distribution server and a client apparatus and adjusting the time based on the smallest one of the measured values.

As described above, wireless communication tends to cause communication jitter delay due to retransmission and transmission wait processes. This can lead to deterioration in the precision of time synchronization in the case where time adjustment by PTP is performed via wireless communication, such as communication using a wireless LAN.

### SUMMARY

According to an aspect of the present disclosure, a client apparatus includes a communication unit configured to communicate with a server apparatus that is a time synchronization source under a time synchronization protocol, and a time synchronization processing unit configured to adjust a time on a clock of the client apparatus to synchronize with a time on a clock of the server apparatus based on a result of the communication, wherein the time synchronization processing unit calculates a reception interval at which a synchronization message transmitted by the server apparatus at a regular time interval is received in time synchronization protocol communication, determines whether the reception interval of the synchronization message is stable, and adjusts the time on the clock of the own apparatus based on a result of the determination.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic system configuration of a synchronized imaging system.

FIG. 2 is a diagram illustrating an example of a hardware configuration of a communication apparatus.

FIG. 3 is a sequence diagram illustrating an example of a Precision Time Protocol (PTP) communication sequence.

FIG. 4 is a diagram illustrating an example of reception history data.

FIG. 5 is a flowchart illustrating an example of processing by a client apparatus.

FIG. 6 is a flowchart illustrating an example of processing by the client apparatus.

FIG. 7 is a diagram illustrating an example of reception intervals in reception history data.

FIGS. 8A and 8B are diagrams illustrating examples of reception intervals in reception history data.

FIG. 9 is a sequence diagram illustrating an example of a PTP communication sequence.

FIG. 10 is a flowchart illustrating an example of processing by a time distribution server apparatus.

FIG. 11 is a flowchart illustrating an example of processing by a client apparatus.

### DESCRIPTION OF THE EMBODIMENTS

Hereinafter, Embodiments of the present disclosure will be described in detail with reference to the accompanying drawings.

In this specification and drawings, components having substantially identical functional configurations are denoted by identical reference numerals, and duplicated descriptions thereof will be omitted.

### First Embodiment

### (System Configuration for Performing Time Synchronization)

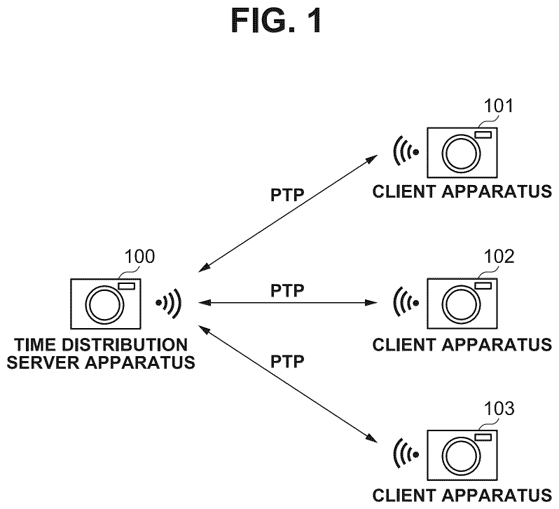

A first embodiment of the present disclosure will be described below. First, referring to FIG. 1, an example of a schematic system configuration of a synchronized imaging system to which a communication apparatus according to the present embodiment is applied will be described. Each of communication apparatuses 100 to 103 is a communication apparatus having an imaging function (in other words, an imaging apparatus having a communication function). That is, in the synchronized imaging system illustrated in FIG. 1, still images and moving images (hereinafter, these will also be collectively referred to as images) of a subject are captured (hereinafter, also referred to as synchronized imaging) by the four imaging apparatuses (communication apparatuses 100 to 103 having an imaging function) in synchronization with one another.

In synchronized imaging, in order to synchronize the imaging timings of a plurality of imaging apparatuses with high precision, it is necessary to synchronize the system times of the imaging apparatuses (communication apparatuses) with high precision. In the example illustrated in FIG. 1, for the sake of convenience, among the four communication apparatuses, the communication apparatus 100 operates as a time distribution server that is the time synchronization source, and the communication apparatuses 101, 102, and 103 operate as clients that synchronize with the time on the communication apparatus 100. Hereinafter, the communication apparatus 100 that is the time synchronization source will also be referred to as time distribution server apparatus 100. The communication apparatuses 101, 102, and 103 that synchronize with the time on the time distribution server apparatus 100 will also be referred to as client apparatuses 101, 102, and 103.

In the present embodiment, the time distribution server apparatus 100 operates as a wireless local area network (LAN) access point, and each of the client apparatuses 101, 102, and 103 wirelessly connects to the time distribution server apparatus 100. Each of the client apparatuses 101, 102, and 103 performs time synchronization with the time distribution server apparatus 100 via Precision Time Protocol (PTP) communication. The time distribution server apparatus 100 has the function of a Grand Master Clock (GMC) and a Boundary Clock (BC), which serve as the time synchronization source for PTP.

### (Hardware Configuration of Communication Apparatus)

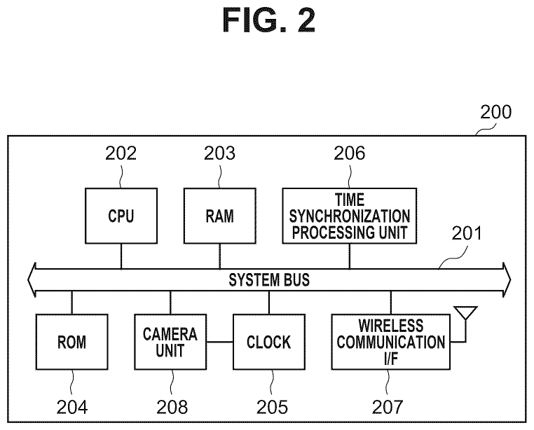

An example of a hardware configuration of a communication apparatus including an imaging function according to the present embodiment will be described with reference to FIG. 2. A communication apparatus 200 illustrated in FIG. 2 is an apparatus that can be applied as each of the time distribution server apparatus 100 and the client apparatuses 101, 102, and 103 illustrated in FIG. 1.

In the example illustrated in FIG. 2, a central processing unit (CPU) 202, a random access memory (RAM) 203, and a read only memory (ROM) 204 are connected to a system bus 201.

The CPU 202 controls the overall operations of the communication apparatus 200 by loading and executing programs stored in the ROM 204. The RAM 203 is used as a temporary storage area in which system programs and application programs are loaded at the time of execution. The ROM 204 is a storage area for storing various programs and data, such as the system programs and application programs, and can be implemented by a non-volatile recording medium.

Furthermore, a clock 205 and a time synchronization processing unit 206 are connected to the system bus 201.

The clock 205 keeps the system time in the communication apparatus 100. The clock 205 has a function of generating and outputting pulse signals with frequencies of 1 Hz, 25 Hz, 29.97 Hz, and the like based on the time. The time synchronization processing unit 206 executes processes related to the control of the clock 205, such as PTP communication process and time adjustment. The clock 205 may be implemented in a configuration included in the wireless communication interface 207, or may be implemented as a software clock executed by the CPU 202.

The time synchronization processing unit 206 has the functions of PTP GMC and BC as a time distribution server, and the client function for performing time synchronization. The time synchronization processing unit 206 can be implemented as a microprocessor different from the CPU 202 and software executed thereon.

A wireless communication interface 207 includes a wireless communication controller implemented by an integrated circuit (IC) or the like, and an antenna for transmission and reception of wireless communication signals. The wireless communication interface 207 is connected to the system bus 201 and controlled by software executed by the CPU 202. The communication apparatus 200 establishes a wireless communication link with another communication apparatus by using the wireless communication interface 207 to transmit and receive packets. In relation to the present embodiment, various descriptions will be given focusing on a case where a wireless LAN (Wi-Fi (registered trademark)) is used for wireless communication. However, the type of wireless communication to be used is not limited. As a specific example, wireless communication compliant with other wireless communication standards such as private Long Term Evolution (LTE), local 5G, and the like may also be used.

A camera unit 208 includes an imaging element that converts a subject image (optical image of a subject) into an electrical signal to generate image data. The camera unit 208 also includes a lens unit that forms the subject image on the imaging element and an image processing unit that performs image processing on the image data. A storage medium unit stores the image data. The camera unit 208 receives the pulse signal output from the clock 205 described above and generates imaging timing at a frame rate of 59.94 fps, 50 fps, or the like. That is, the communication apparatus 200 generates imaging timing from the time when synchronization with another communication apparatus is achieved, thereby enabling imaging in synchronization with the other communication apparatus.

### (PTP Communication Sequence)

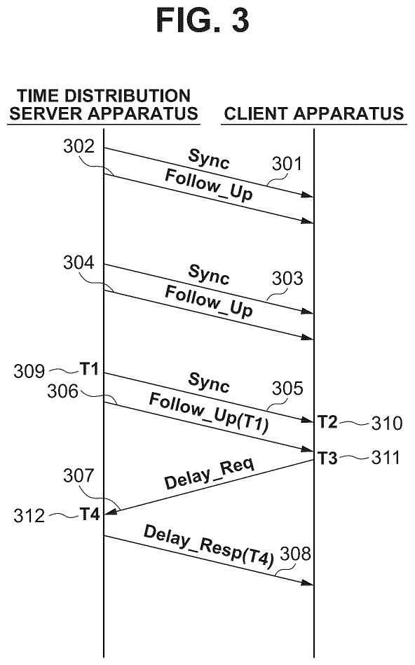

Next, a communication sequence for time synchronization will be described. FIG. 3 is a diagram illustrating an example of a PTP communication sequence between the time distribution server apparatus 100 and the client apparatus 101.

In the example illustrated in FIG. 3, the minimum communication required for time synchronization with the client apparatus is illustrated.

The time distribution server apparatus 100 continues to transmit synchronization message (SYNC) packets at regular time intervals. The client apparatus 101 receives the synchronization messages from the time distribution server apparatus 100. In the example illustrated in FIG. 3, packets 301, 303, and 305 represent synchronization messages.

The time distribution server apparatus 100 also acquires a transmission time stamp at the time indicated by the clock 205 of the own apparatus when transmitting a synchronization message, and transmits a follow-up message (Follow_Up) packet that stores the transmission time stamp. In the example illustrated in FIG. 3, packets 302, 304, and 306 indicate follow-up messages.

The client apparatus 101 receives the follow-up message to obtain the transmission time of the synchronization message. Also, upon receipt of the synchronization message, the client apparatus 101 acquires a reception time stamp at the time indicated by the clock 205 of the own apparatus.

Upon receipt of a synchronization message, the client apparatus 101 acquires the reception interval from the previous synchronization message. The reception interval is acquired as the time difference between reception time stamps. The client apparatus 101 holds the acquired reception interval as synchronization message reception history data.

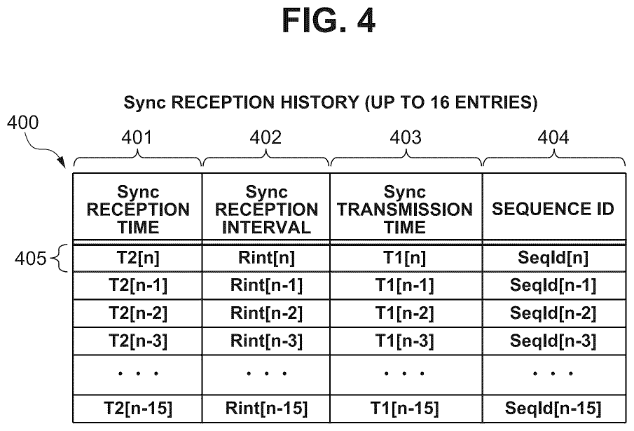

FIG. 4 is a diagram illustrating, in tabular form, an example of information held as reception history data 400 of the client apparatus 101. Each entry of the reception history includes a sync reception time 401 of the synchronization message and a sync reception interval 402, which is the reception interval from the previous received message. Each entry of the reception history also includes a sync transmission time 403, which is the transmission time of the synchronization message obtained from the follow-up message, and a sequence ID 404, which is the identifier assigned to the synchronization message. One entry 405 is a set of these parameters.

The entries of the reception history data 400 are held up to a preset maximum number. In the example illustrated in FIG. 4, up to 16 entries can be held. If a new synchronization message is received, an entry is added to the reception history data 400. If the number of entries exceeds the predetermined number of holdable entries, the history data (entry) of the oldest synchronization message is discarded, and then the new history data (entry) is added.

In this way, the client apparatus 101 holds history data (entries) of a predetermined number of recently received messages.

Furthermore, the client apparatus 101 determines whether the reception intervals of the synchronization messages are stable, based on the synchronization message reception history data. If the client apparatus 101 determines that the reception intervals of the synchronization messages are stable, the client apparatus 101 transmits a delay request message (Delay_Req). In the example illustrated in FIG. 3, a packet 307 represents the delay request message. When transmitting the delay request message, the client apparatus 101 acquires and stores a transmission time stamp at the time indicated by the clock 205 of the own apparatus.

Upon receipt of the delay request message from the client apparatus 101, the time distribution server apparatus 100 acquires a reception time stamp at the time indicated by its clock 205. The time distribution server apparatus 100 then stores the reception time stamp in a delay response message (Delay_Resp) and transmits the same to the client apparatus 101. In the example illustrated in FIG. 3, a packet 308 represents the delay response message.

Upon receipt of the delay response message, the client apparatus 101 calculates a time difference ΔT between the clock 205 of the own apparatus and the clock 205 of the time distribution server apparatus 100. In calculating the time difference ΔT, used are a transmission time T1 and a reception time T2 of the latest synchronization message at the point in time of transmission of the delay request message, and a transmission time T3 and a reception time T4 of the delay request message. In the example illustrated in FIG. 3, times T1 (309), T2 (310), T3 (311), and T4 (312) are used in the calculation of the time difference ΔT. The time difference ΔT between the clock 205 of the client apparatus 101 and the clock 205 of the time distribution server apparatus 100 is calculated using the following equation (Equation 1):

$$Δ T = ( ( T 2 - T 1 ) - ( T 4 - T 3 ) ) / 2 is \qquad ( Equation 1 )$$

Then, the client apparatus 101 corrects the time on the clock 205 of the own apparatus based on the time difference ΔT.

The above describes the PTP communication sequence between the time distribution server apparatus 100 and the client apparatus 101 for the client apparatus 101 to achieve time synchronization with the time distribution server apparatus 100. Note that the above communication sequence with the time distribution server apparatus 100 is executed not only for the client apparatus 101 but also for other client apparatuses (for example, the client apparatuses 102 and 103 illustrated in FIG. 1). The time distribution server apparatus 100 may not only periodically transmit a synchronization message but also periodically multicast packets for other purposes, regardless of the communication sequence illustrated in FIG. 3. Examples of such packets include an announce message packet used by the time distribution server apparatus 100 to notify other communication apparatuses of its presence in the network, provide information on the precision of its clock, and the like.

### (Flow of Processing by Client Apparatus 101)

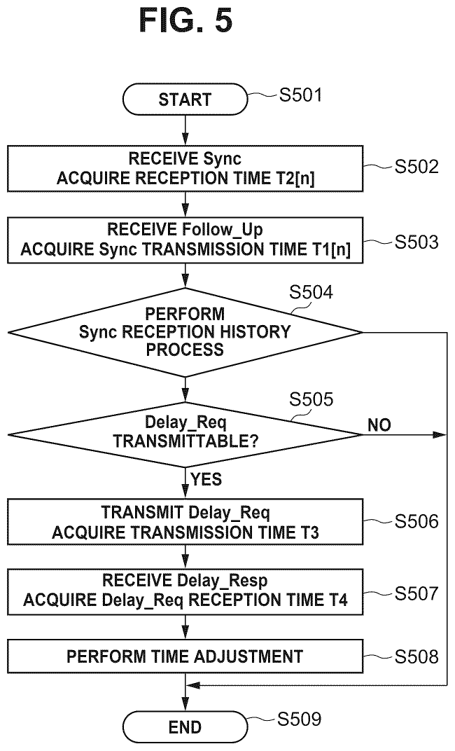

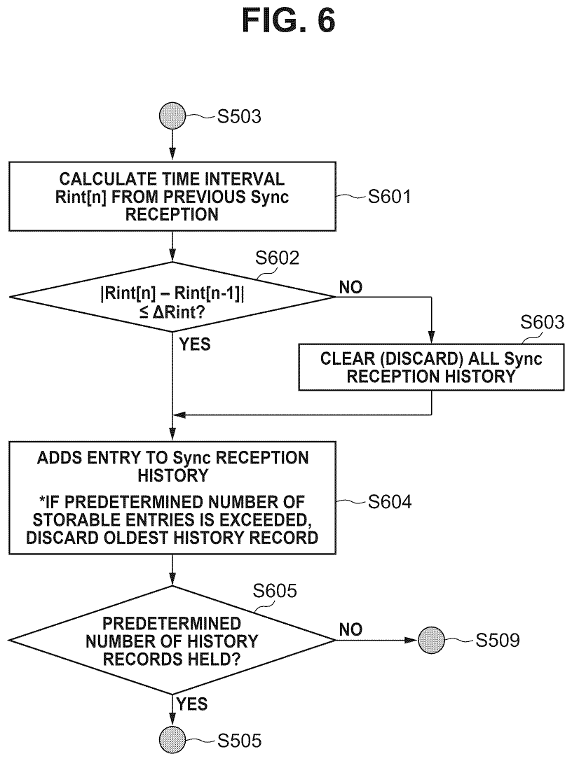

Next, an example of processing by the time synchronization processing unit 206 of the client apparatus 101 will be described with reference to FIGS. 5 and 6. FIGS. 5 and 6 are flowcharts illustrating an example of processing by the client apparatus 101, focusing in particular on PTP communication processing. The time synchronization processing unit 206 repeatedly executes a series of steps from the start (step S501) to the end (step S509). Hereinafter, the contents of the series of steps will be described in detail.

In step S502, the time synchronization processing unit 206 receives a synchronization message periodically transmitted from the time distribution server apparatus 100. The time synchronization processing unit 206 acquires a time stamp of reception time T2[n] of the synchronization message. Note that n is a variable that individually indicates each of synchronization messages periodically transmitted at predetermined time intervals, and may take a positive integer value. As a specific example, the reception time T2[n] indicates the reception time T2 of the n-th transmitted synchronization message.

In step S503, the time synchronization processing unit 206 receives a follow-up message from the time distribution server apparatus 100. The time synchronization processing unit 206 acquires from the follow-up message a time stamp of transmission time T1[n] of the synchronization message received in step S502.

In step S504, the time synchronization processing unit 206 executes a synchronization message reception history process.

The details of step S504 illustrated in FIG. 5 will be described with reference to FIG. 6.

In step S601, the time synchronization processing unit 206 calculates a reception interval Rint[n], which is the time from the reception time of the previous synchronization message to the reception time of the current synchronization message received in step S502.

In step S602, the time synchronization processing unit 206 determines whether the absolute value of the difference between the previous reception interval Rint[n−1] of synchronization messages and the current reception interval Rint[n] of synchronization messages is equal to or less than a predetermined threshold ΔRint. In other words, the time synchronization processing unit 206 determines whether the current reception interval Rint[n] of synchronization messages is within a predetermined range of fluctuation from the previous reception interval Rint[n−1] of synchronization messages.

If the time synchronization processing unit 206 determines in step S602 that the absolute value of the difference between the two reception intervals (that is, the reception intervals Rint[n−1] and Rint[n]) is equal to or less than the threshold ΔRint (YES in step S602), the process proceeds to step S604.

On the other hand, if the time synchronization processing unit 206 determines in step S602 that the absolute value of the difference between the two reception intervals exceeds the threshold ΔRint (NO in step S602), the process proceeds to step S603. The value of the threshold ΔRint may be 1/1000 of the period of cycle of the synchronization messages transmitted at a constant frequency by the time distribution server apparatus 100, for example.

In step S603, the time synchronization processing unit 206 discards all synchronization message reception history data and clears the reception history.

In step S604, the time synchronization processing unit 206 adds a history entry relating to the reception of the current synchronization message to the reception history data. The added entry includes parameters T2[n], Rint[n], T1[n], and SeqId[n], which is the sequence ID of the synchronization message, as illustrated by the entry 405 in FIG. 4.

In step S605, the time synchronization processing unit 206 determines whether the number of history records (entries) held in the reception history data is a predetermined number. In the example illustrated in FIG. 4, the predetermined number is 16.

If the time synchronization processing unit 206 determines in step S605 that the number of history records held in the reception history data is equal to the predetermined number (YES in step S605), the process proceeds to step S505 illustrated in FIG. 5.

On the other hand, if the time synchronization processing unit 206 determines in step S605 that the number of history records stored in the reception history data is not the predetermined number (NO in step S605), the process proceeds to step S509 illustrated in FIG. 5. Accordingly, the series of steps illustrated in FIGS. 5 and 6 is ended. Here, reference is again made to FIG. 5.

In step S505, the time synchronization processing unit 206 determines whether a delay request message can be transmitted. Details of the determination process will be described separately below. If the time synchronization processing unit 206 determines that a delay request message can be transmitted (YES in step S505), the process proceeds to step S506. If the time synchronization processing unit 206 determines that no delay request message can be transmitted (NO in step S505), the process proceeds to step S509. Accordingly, the series of steps illustrated in FIG. 5 ends.

In step S506, the time synchronization processing unit 206 transmits a delay request message to the time distribution server apparatus 100, and acquires a transmission time stamp based on the time on the clock 205 of the own apparatus at the time of transmission, thereby obtaining a transmission time T3 of the delay request message.

In step S507, the time synchronization processing unit 206 receives a delay response message from the time distribution server apparatus 100, and acquires a reception time T4 of the delay request message stored in the delay response message.

In step S508, the time synchronization processing unit 206 uses the times T1[n], T2[n], T3, and T4 to calculate the time difference (offset) between the clock of the client apparatus 101 including the own unit and the clock of the time distribution server apparatus 100. The time synchronization processing unit 206 adjusts the time on the clock 205 of the client apparatus 101 based on the time difference.

### (Determination on Whether Delay Request Message can be Transmitted)

Two exemplary methods for determining whether a delay request message can be transmitted in step S505 are illustrated in FIG. 5.

The first method is to determine whether a delay request message can be transmitted depending on whether the reception intervals of all synchronization messages in the reception history data are within a predetermined threshold.

According to this method, if all of the reception intervals are within a predetermined threshold, it is determined that a delay request message can be transmitted. On the other hand, if any of the reception intervals exceeds the threshold, it is determined that no delay request message can be transmitted.

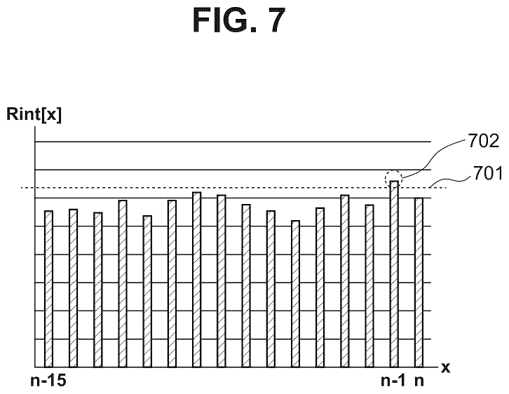

FIG. 7 is a diagram illustrating an example of reception intervals in the reception history data, where the reception intervals are illustrated in a bar graph. The vertical axis of the graph illustrated in FIG. 7 represents the length of the reception interval Rint. The horizontal axis corresponds to the entries of the reception history data 400 illustrated in FIG. 4.

Each bar in the graph illustrated in FIG. 7 represents the length of the reception interval. Also, the dotted line 701 in FIG. 7 indicates the threshold line for the reception interval. In the example illustrated in FIG. 7, Rint[n−1] exceeds the threshold as illustrated by a circle 702. In this case, it is determined that no delay request message can be transmitted.

The second method is to determine whether a delay request message can be transmitted depending on whether the reception interval of the latest synchronization message is within the standard deviation of all the reception intervals in the reception history data. The average value and standard deviation of the reception intervals of the reception history data are calculated, and it is determined whether the value of the reception interval of the latest history record is within the range of the average value±the standard deviation.

If the reception interval of the latest received message is within the standard deviation, it is determined that a delay request message can be transmitted. On the other hand, if the reception interval of the latest received message is not within the standard deviation, it is determined that no delay request message can be transmitted.

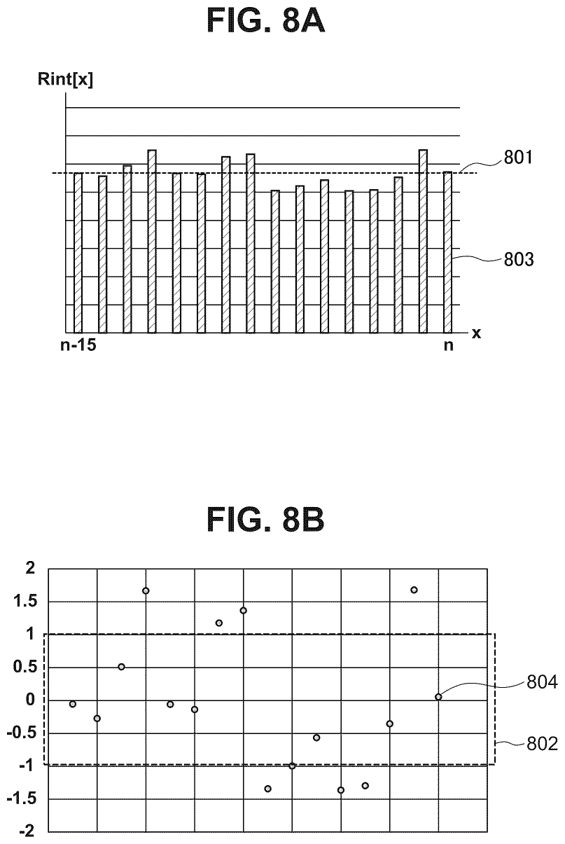

FIG. 8A is a diagram illustrating an example of reception intervals in the reception history data, where the reception intervals are illustrated in a bar graph. The vertical axis of the graph illustrated in FIG. 8A represents the length of the reception interval Rint. The horizontal axis corresponds to the entries of the reception history data 400 illustrated in FIG. 4. The dotted line 801 in FIG. 8A indicates the average value of all the reception intervals.

FIG. 8B is a scatter diagram on which the results of standardizing the reception intervals illustrated in the bar graph in FIG. 8A are plotted (the results represent converting the values of the reception intervals such that the average is 0 and the variance is 1). The vertical axis of the scatter diagram illustrated in FIG. 8B indicates the reception intervals after standardization. The horizontal axis corresponds to the horizontal axis of the graph illustrated in FIG. 8A. In the scatter diagram illustrated in FIG. 8B, data in which the reception intervals after standardization are dotted in the range of −1 to +1 corresponds to reception intervals that fall within the standard deviation.

The value 803 illustrated in FIG. 8A indicates the value of the reception interval of the latest synchronization message.

The standardized value of the reception interval 803 is illustrated as a dot 804 in FIG. 8B. That is, in the example illustrated in FIGS. 8A and 8B, since the reception interval of the latest synchronization message is within the standard deviation, it is determined that a delay request message can be transmitted.

The two determination methods have been described as examples of the process of determining in step S505 whether a delay request message can be transmitted. The determination may be made by combining the two determination methods.

As described above, in the present embodiment, the client apparatus 101 determines whether a delay request message can be transmitted based on the history data of the reception intervals of synchronization messages transmitted from the time distribution server apparatus 100. The determination is made on whether the reception intervals of the synchronization messages are stable. If the reception intervals of the synchronization messages are stable, it means that the jitter in the communication delay of the wireless communication from the time distribution server apparatus 100 to the client apparatus 101 is small. That is, the determination makes it possible to obtain an appropriate timing for transmitting a delay request message and adjusting the clock 205. Furthermore, this time synchronization method based on the determination can reduce the number of communication packets in PTP communication as compared to a case where time synchronization is performed by periodically transmitting a delay request message at random intervals. Therefore, it can be expected that this method is effective in reducing the influence of fluctuations in the communication delay of PTP packets in environments where communication delays are likely to occur, such as wireless communication environments.

### Second Embodiment

A second embodiment of the present disclosure will be described below. In the second embodiment, a system configuration of a system that performs time synchronization is substantially the same as that of the first embodiment. Furthermore, substantially the same configurations as those of the first embodiment can be applied to hardware configurations of a time distribution server apparatus 100 and client apparatuses 101 to 103. Hereinafter, features of the present embodiment will be described, showing the similarities with and differences from the first embodiment.

### (PTP Communication Sequence)

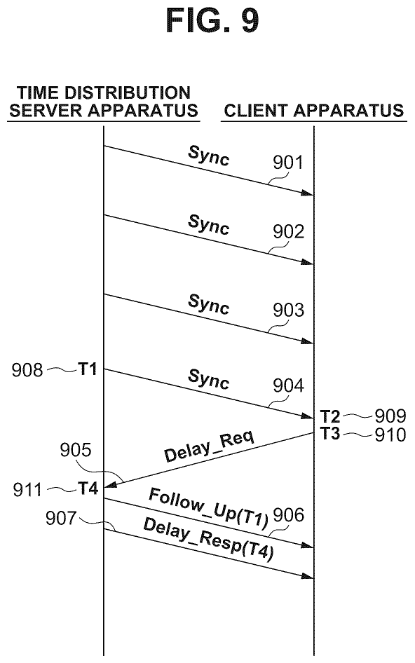

First, referring to FIG. 9, a PTP communication sequence for time synchronization between the time distribution server apparatus 100 and the client apparatus 101 will be described. FIG. 9 illustrates an example of the minimum communication required for time synchronization of the client apparatus. As in the first embodiment, the time distribution server apparatus 100 transmits synchronization message (SYNC) packets 901 to 904 at regular time intervals. The time distribution server apparatus 100 acquires transmission time stamps of the packets to obtain the transmission times of the synchronization messages. In the present embodiment, however, unlike the first embodiment, the time distribution server apparatus 100 does not transmit a follow-up message at each time of transmission of a synchronization message. Instead, after transmission of a synchronization message, the time distribution server apparatus 100 stores the value of sequence ID of the synchronization message in association with the transmission time.

On the other hand, as in the first embodiment, the client apparatus 101 acquires the reception time at each time of reception of a synchronization message and acquires the time interval from the reception time of the previous synchronization message as the reception interval of the synchronization message. The client apparatus 101 also stores reception history data including the reception times of the synchronization messages, the reception interval from the previous reception, and the sequence ID parameters. In the present embodiment, however, unlike the first embodiment, no follow-up message that would arrive after a synchronization message is received, and therefore the reception history data does not include the transmission times of the synchronization messages. As in the first embodiment, the client apparatus 101 updates the reception history data upon receipt of a synchronization message. If a predetermined number of history records have been held, the client apparatus 101 determines whether a delay request message can be transmitted. If the client apparatus 101 determines that a delay request message can be transmitted, the client apparatus 101 transmits a delay request message to the time distribution server apparatus 100.

FIG. 9 illustrates a delay request message (Delay_Req) 905 that is transmitted by the client apparatus 101 to the time distribution server apparatus 100. In the present embodiment, the value of the sequence ID stored in the delay request message 905 is set to an ID value similar to the value of the sequence ID of the latest synchronization message received by the client apparatus 101 (synchronization message 904 in the example illustrated in FIG. 9). In transmitting the delay request message 905, the client apparatus 101 acquires transmission time T3 (910).

Upon receipt of the delay request message 905, the time distribution server apparatus 100 acquires reception time T4 (911). Then, from the stored transmission times of the synchronization messages, the time distribution server apparatus 100 selects and acquires transmission time T1 (transmission time 908) of the synchronization message that has a sequence ID that is the same as the sequence ID stored in the delay request message. The time distribution server apparatus 100 then stores the transmission time T1 in a follow-up message (Follow_Up) 906 and transmits the message to the client apparatus 101. The time distribution server apparatus 100 also stores the reception time T4 (911) of the delay request message 905 in a delay response message (Delay_Resp) 907 and transmits the message to the client apparatus 101.

Upon receipt of the follow-up message 906 and the delay response message 907, the client apparatus 101 acquires the transmission time T1 and the reception time T4 stored in the messages. The client apparatus 101 also acquires, from the reception history data, reception time T2 of the latest synchronization message at the time of transmission of the delay request message (reception time 909 in the example illustrated in FIG. 9). In this manner, the client apparatus 101 acquires the transmission time T1 (908), the reception time T2 (909), the transmission time T3 (910), and the reception time T4 (911). The client apparatus 101 then applies these acquired times to the above-described (Equation 1) to calculate a time difference (offset) ΔT between the clock of the time distribution server apparatus 100 and the clock of the own apparatus, and adjusts the time on the clock of the own apparatus based on the time difference ΔT.

### (Flow of Processing by Time Distribution Server Apparatus 100)

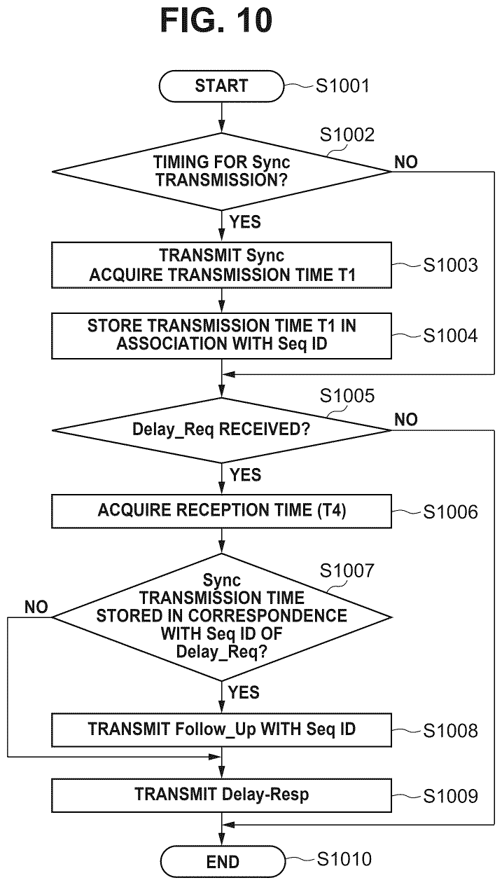

Next, referring to FIG. 10, an example of processing by the time distribution server apparatus 100 will be described, focusing on the processing in the PTP communication described above with reference to FIG. 9. A time synchronization processing unit 206 of the time distribution server apparatus 100 repeatedly executes a series of steps from the start (step S1001) to the end (step S1010).

In step S1002, the time synchronization processing unit 206 determines whether the timing is timing to transmit a synchronization message to be periodically transmitted at fixed time intervals.

If the time synchronization processing unit 206 determines in step S1002 that the timing is timing to transmit a synchronization message (YES in step S1002), the process proceeds to step S1003.

On the other hand, if the time synchronization processing unit 206 determines in step S1002 that the timing is not timing to transmit a synchronization message (NO in step S1002), the process proceeds to step S1005.

In step S1003, the time synchronization processing unit 206 transmits a synchronization message to the client apparatus 101 and acquires the transmission time T1.

In step S1004, the time synchronization processing unit 206 stores the sequence ID of the synchronization message transmitted in step S1003 in association with the transmission time T1. The number of transmission times to be stored is the same as the predetermined number of pieces of reception history data held by the client apparatus 101.

In step 1005, the time synchronization processing unit 206 determines whether a delay request message has been received from the client apparatus 101.

If the time synchronization processing unit 206 determines in step S1005 that no delay request message has been received (NO in step S1005), the process proceeds to step S1010, and the series of steps illustrated in FIG. 10 ends.

On the other hand, if the time synchronization processing unit 206 determines in step S1005 that a delay request message has been received (YES in step S1005), the process proceeds to step S1006.

In step S1006, the time synchronization processing unit 206 acquires the reception time T4 of the delay request message from the reception time stamp of the packets.

In step S1007, the time synchronization processing unit 206 determines whether the transmission time of the synchronization message associated with the same sequence ID as the sequence ID of the received delay request message is stored.

If the time synchronization processing unit 206 determines in step S1007 that the corresponding transmission time is stored (YES in step S1007), the process proceeds to step S1008.

On the other hand, if the time synchronization processing unit 206 determines in step S1007 that the corresponding transmission time is not stored (NO in step S1007), the process proceeds to step S1009.

In step 1008, the time synchronization processing unit 206 creates a Follow_Up message using the sequence ID and the transmission time identified in step 1007, and transmits the message to the client apparatus 101.

In step S1009, the time synchronization processing unit 206 transmits a delay response message including the reception time T4 in response to the delay request message received from the client apparatus 101.

Then, in step S1010, the series of steps illustrated in FIG. 10 ends.

### (Flow of Processing by Client Apparatus 101)

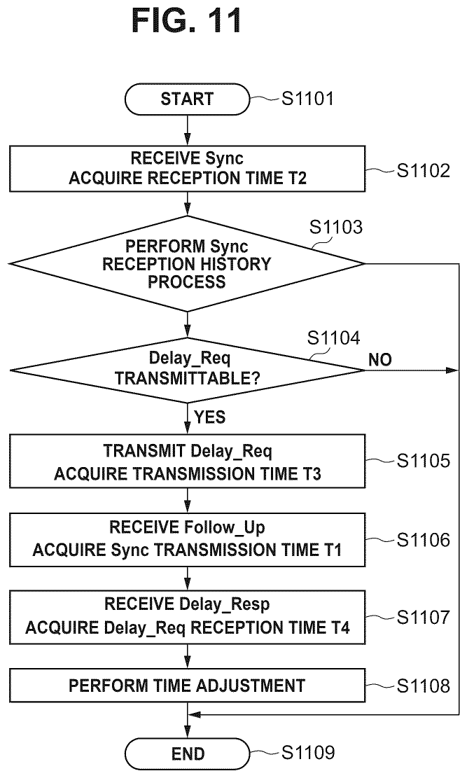

Next, referring to FIG. 11, an example of processing by the client apparatus 101 will be described, focusing on the processing in the PTP communication described above with reference to FIG. 9. The time synchronization processing unit 206 repeatedly executes a series of steps from the start (step S1101) to the end (step S1109). The contents of the series of steps will be described below, focusing on the differences from the first embodiment described above.

Steps S1102, S1103, and S1104 correspond to steps S502, S504, and S505 in the example illustrated in FIG. 5.

At the transmission of a delay request message in step S1105, the time synchronization processing unit 206 sets the value of the sequence ID of the last received synchronization message to the delay request message. The sequence ID is extracted to be used from the history entry of the latest synchronization message stored in the reception history data.

In the series of steps described with reference to FIG. 5 in the first embodiment, the time synchronization processing unit 206 receives a synchronization message in step S502 and then receives a follow-up message in step S503. In contrast, in the present embodiment, the time synchronization processing unit 206 transmits a delay request message in step S1105 and then receives a follow-up message in step S1106. The time synchronization processing unit 206 can acquire the transmission time T1 of the synchronization message with the sequence ID used in step S1105 from the follow-up message received in step S1106.

Step S1107 corresponds to step S507 in the example illustrated in FIG. 5.

In step S1108, the time synchronization processing unit 206 uses the transmission time T1, the reception time T2, the transmission time T3, and the reception time T4 to calculate the time difference (offset) ΔT between the clock of the own apparatus and the clock of the time distribution server apparatus 100. In this case, the applied transmission time T1 is the transmission time acquired from the follow-up message received in step S1106, that is, the transmission time of the synchronization message with the sequence ID used in step S1105. In addition, the applied transmission time T3 is the transmission time of the delay request message transmitted in step S1105.

As described above, in the present embodiment, the time distribution server apparatus 100 does not transmit a follow-up message at each time of transmission of a synchronization message. Instead, the time distribution server apparatus 100 transmits a follow-up message that notifies the transmission time of the synchronization message with the sequence ID specified in the delay request message from the client apparatus 101. Applying such control makes it possible to reduce the number of communication packets in PTP communication. That is, in the present embodiment, it is possible to reduce fluctuations in the communication delay of PTP packets as in the first embodiment described above, and it is also possible to expect the effect of further improving the effect of reducing the fluctuations.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-195010, filed Nov. 7, 2024, which is hereby incorporated by reference herein in its entirety.

What is claimed is:

1. A client apparatus comprising:
a communication unit configured to communicate with a server apparatus that is a time synchronization source under a time synchronization protocol; and
a time synchronization processing unit configured to adjust a time on a clock of the client apparatus to synchronize with a time on a clock of the server apparatus based on a result of the communication,
wherein the time synchronization processing unit calculates a reception interval at which a synchronization message transmitted by the server apparatus at a regular time interval is received in time synchronization protocol communication, determines whether the reception interval of the synchronization message is stable, and adjusts the time on the clock of the own apparatus based on a result of the determination.

2. The client apparatus according to claim 1, wherein the time synchronization processing unit stores the reception interval of the synchronization message as history data, and determines whether the reception interval of the synchronization message is stable based on the history data.

3. The client apparatus according to claim 2, wherein if an absolute value of a difference between a latest reception interval of the synchronization message and a previous reception interval of the synchronization message is equal to or less than a threshold, the time synchronization processing unit stores the latest reception interval of the synchronization message as the history data.

4. The client apparatus according to claim 2, wherein if all reception intervals stored as the history data are within a predetermined threshold, the time synchronization processing unit determines that the reception interval of the synchronization message is stable.

5. The client apparatus according to claim 2, wherein if a latest reception interval of the synchronization message is within a standard deviation of all reception intervals stored as the history data, the time synchronization processing unit determines that the reception interval of the synchronization message is stable.

6. The client apparatus according to claim 1, wherein if the time synchronization processing unit determines that the reception interval of the synchronization message is stable, the communication unit transmits a delay request message to the server apparatus and receives a delay response message from the server apparatus in response to the delay request message.

7. The client apparatus according to claim 6,
wherein the communication unit transmits the delay request message including an identifier of a latest synchronization message to the server apparatus, and then receives a follow-up message that is transmitted from the server apparatus to notify a transmission time of the synchronization message indicated by the identifier, and
wherein the time synchronization processing unit calculates a time difference between the time on the clock of the server apparatus and the time on the clock of the own apparatus, based on the transmission time stored in the follow-up message, in order to adjust the time on the clock of the own apparatus.

8. The client apparatus according to claim 6,
wherein the communication unit receives a follow-up message that is transmitted from the server apparatus after the transmission of the synchronization message, to notify a transmission time of the synchronization message, and
wherein the time synchronization processing unit calculates a time difference between the time on the clock of the server apparatus and the time on the clock of the own apparatus, based on the transmission time stored in the follow-up message, in order to adjust the time on the clock of the own apparatus.

9. A control method of a client apparatus, comprising:
communicating with a server apparatus that is a time synchronization source under a time synchronization protocol; and
performing time synchronization to adjust a time on a clock of the client apparatus to synchronize with a time on a clock of the server apparatus based on a result of the communication,
wherein the performing time synchronization includes calculating a reception interval at which a synchronization message transmitted by the server apparatus at a regular time interval is received in time synchronization protocol communication, determining whether the reception interval of the synchronization message is stable, and adjusting the time on the clock of the own apparatus based on a result of the determination.

10. A non-transitory storage medium storing a program causing a client apparatus to execute a control method, the control method comprising:
communicating with a server apparatus that is a time synchronization source under a time synchronization protocol; and
performing time synchronization to adjust a time on a clock of the client apparatus to synchronize with a time on a clock of the server apparatus based on a result of the communication,
wherein the performing time synchronization includes calculating a reception interval at which a synchronization message transmitted by the server apparatus at a regular time interval is received in time synchronization protocol communication, determining whether the reception interval of the synchronization message is stable, and adjusting the time on the clock of the own apparatus based on a result of the determination.
